(19) United States
(12) Patent Application Publication
(10) Pub. No.: US 2026/0276505 A1
(43) Pub. Date: Sep. 17, 2026

(54) TEST EQUIPMENT AND TEST METHOD FOR SIMULATING EROSION OF SHIP PLATE STEEL IN POLAR BROKEN ICE WATERS

(71) Applicant: Ocean University of China, Qingdao City (CN)

(72) Inventors: Zhongyu CUI, Qingdao City (CN); Zhenbang HAN, Qingdao City (CN); Huiyun TIAN, Qingdao City (CN); Cheng MAN, Qingdao City (CN); Hongzhi CUI, Qingdao City (CN)

(21) Appl. No.: 19/560,888

(22) Filed: Mar. 9, 2026

(30) Foreign Application Priority Data
Mar. 11, 2025 (CN) 202510283706.1

(51) Int. Cl. G01N 3/56; G01N 3/04

(52) U.S. Cl. CPC G01N 3/567; G01N 3/04; G01N 2203/0228

(57) ABSTRACT

Test equipment and a test method for simulating erosion of a ship plate steel in polar broken ice waters. The test equipment includes an ice-water mixed wear test box, a rotating sample clamp device, and a circulating temperature control device; the rotating sample clamp device is located in the ice-water mixed wear test box, the rotating sample clamp device includes a stirring motor installed on a stirring support frame, the stirring support frame is installable on a test material barrel, an output shaft of the stirring motor is connected with a rotating sample clamp bracket, the rotating sample clamp bracket is connected with a plurality of clamp bodies, the clamp bodies are configured to fix samples; and the circulating temperature control device includes a constant temperature water bath box and a circulating temperature control outer barrel.

### CROSS-REFERENCE TO RELATED APPLICATION

This patent application claims the benefit and priority of Chinese Patent Application No. 202510283706.1 filed with the China National Intellectual Property Administration on Mar. 11, 2025, the disclosure of which is incorporated by reference herein in its entirety as part of the application.

### TECHNICAL FIELD

The present disclosure relates to the technical field of a device for simulating ice-water erosion of a steel plate, and in particular, to a test equipment and a test method for simulating erosion of a ship plate steel in polar broken ice waters.

### BACKGROUND

Due to uniqueness of a polar region in geopolitics, economy, environment, and military affairs, all countries pay special attention to polar resources. Polar ships navigates in a periglacial region of the Arctic and Antarctic during summer. Expansion of a window period of the Arctic and Antarctic routes leads to an increasing demand for ships to navigate in broken ice waters. In order to deal with an impact of broken ice in polar broken ice waters, a polar ship steel plays a very important role in performance of ships navigating in a polar region. On the one hand, there may be coating peeling off when polar ships navigate, so that a substrate is exposed, and an ice-water erosion test plays a key role in selection of a ship plate steel. On the other hand, the ice-water erosion test of the ship plate steel provides scientific basis for subsequent coating development, local ship structure strengthening, and a new ship structure design.

At present, there are very few erosion data of a polar steel ice-water environment and devices for simulating polar environment navigation. It is very difficult to carry out a polar marine environment test. There is no such marine environment in adjacent waters of China, so that it is impossible to carry out near-sea tests. Moreover, although a full-scale sea test is true and accurate, the test has the following shortcomings. First, it takes a lot of manpower, material resources and financial resources to simulate an ice-water environment in a polar region. Second, after a polar environment test is finished, it is impossible to characterize the test steel in time. Third, the environment is harsh, and there are many uncontrollable factors in a test process. Therefore, it is urgent to develop and design a device for simulating navigation of a ship in polar broken ice waters, thereby filling in the gap.

At present, there are few simulation tests of ice-water erosion in an extreme environment in China. On the one hand, an existing device for simulating erosion and wear in polar broken ice waters cannot control test variables such as an ice-water ratio, an ice shape, a navigation speed, and a navigation mileage, which leads to inaccurate variable control. On the other hand, the device has a large volume, occupies too much space in a test site, and has a high cost. Although simulation is accurate, the degree of automation is low, and it is difficult to perform initial operation. At present, there are mainly three types of erosion test equipments, including a pipe flow type, a jet type, and a rotation type. Patent No. 201610096668.X provides a test equipment for simulating metal corrosion in a dynamic seawater environment. The device belongs to a pipe flow type. The device can control the water temperature well. However, under the condition of ice-water coexistence, reproducibility of a navigation test in broken ice waters is not high. At the same time, it is impossible to carry out determination of parallel samples. Second, a biggest disadvantage of a pipe flow device is that an erosion speed cannot be accurately controlled, and especially an erosion speed on the sample surface cannot be stabilized at a specific value in a long-term test. Patent No. 202011164237.5 mentions a rotation metal erosion corrosion device. The device is a rotation device. The device relies on water bath to control the temperature, resulting in uneven heating of the solution, and eventually leading to freezing of a barrel wall. Second, the device does not solve a problem that an erosion speed cannot be accurately controlled in Application No. 201610096668.X. A jet test equipment is common, but has quite a few problems. On the one hand, for a long-period test, the jet test equipment needs a large amount of solid-liquid two-phase solution. Second, the jet test equipment does not yield satisfactory simulation effects in accurate control of an erosion speed and an impact force, and there are many other problems.

It is not difficult to see from the foregoing prior art that the existing simulation device has a problem that the erosion speed and the impact force cannot be accurately controlled.

Therefore, there is an urgent need for a new test equipment and a new test method for simulating erosion of a ship plate steel in polar broken ice waters, thereby solving the above problems.

### SUMMARY

An objective of the present disclosure is to provide a test equipment and a test method for simulating erosion of a ship plate steel in polar broken ice waters, thereby solving the above problems existing in the prior art, and accurately controlling the erosion speed and the impact force on the sample.

In order to achieve the above objective, the present disclosure provides the following solution.

The present disclosure discloses a test equipment for simulating erosion of a ship plate steel in polar broken ice waters, including an ice-water mixed wear test box, a rotating sample clamp device, and a circulating temperature control device;
the rotating sample clamp device is installed inside the ice-water mixed wear test box, the rotating sample clamp device includes a stirring motor installed on a stirring support frame, the stirring support frame is installable on a test material barrel, an output shaft of the stirring motor is connected with a rotating sample clamp bracket, the rotating sample clamp bracket is connected with a plurality of clamp bodies, the clamp bodies are configured to fix samples, a propeller-driven motor is installed on a bottom surface of the test material barrel, an output shaft of the propeller-driven motor is connected with a counter-thrust propeller, and the counter-thrust propeller is located inside the test material barrel; and
the circulating temperature control device includes a constant temperature water bath box and a circulating temperature control outer barrel, the test material barrel is placed inside the circulating temperature control outer barrel, and a liquid inlet pipe and a liquid outlet pipe are connected between the constant temperature water bath box and the circulating temperature control outer barrel.

Preferably, the stirring support frame includes a support main body and four telescopic clamping plates, each of four corners of the support main body is provided with a first positioning hole, each of the four telescopic clamping plates is provided with a plurality of second positioning holes at intervals, the first positioning hole is connected with one of the second positioning holes through a positioning bolt, and the four telescopic clamping plates are configured to clamp the test material barrel.

Preferably, the rotating sample clamp bracket is a cross-shaped member, each of four ends of the rotating sample clamp bracket is connected with one of the clamp bodies, each clamp body is provided with a plurality of sample empty grooves distributed vertically, two sides of each sample empty grooves are in threaded connection with two sample fixing bolts, respectively, and a sample is clamped between the two sample fixing bolts.

Preferably, the ice-water mixed wear test box is a high-low temperature test box.

Preferably, a side wall of the ice-water mixed wear test box is provided with a plurality of reserved holes.

Preferably, an inner wall of the ice-water mixed wear test box and an inner wall of the test material barrel are both coated with nonmetallic coatings.

Preferably, a flow meter is installed inside the test material barrel.

Preferably, a temperature sensor is installed inside the test material barrel.

Preferably, an erosion angle is formed between the clamp bodies and a tangential direction of the clamp bodies when the clamp bodies rotate, and the erosion angle ranges from 0° to 90°.

The present disclosure discloses a test method carried out by a test equipment for simulating erosion of a ship plate steel in polar broken ice waters, including the following steps:
S1, checking tightness of the equipment and safety of circuit configuration;
S2, setting temperature and humidity of an ice-water mixed wear test box, adding artificial seawater into a test material barrel, uniformly distributing heat of the artificial seawater through rotation of a counter-thrust propeller, and detecting the temperature of the artificial seawater through a temperature sensor;
S3, after the temperature of the artificial seawater in the test material barrel is stabilized, turning on a circulating temperature control device, and adjusting the temperature of the artificial seawater between −1.8° C. and 0° C.;
S4, adding prepared ice cubes into the test material barrel when the temperature of the artificial seawater is stabilized between- 1.8° C. and 0° C.;
S5, selecting rotating sample clamp brackets with different erosion angles according to a specific research position of a ship hull, installing samples on clamp bodies, calculating a navigation distance according to a radius, a rotation speed, and rotation time of the rotating sample clamp bracket, turning on a stirring motor, setting a rotation speed of the stirring motor, and starting timing; and
S6, after the test is finished, drying the samples for sealing or drying the samples for characterization.

Compared with the prior art, the present disclosure has the following technical effects.

According to the present disclosure, a stirring motor is configured to drive a clamp body and a fixed sample thereof to rotate. Artificial seawater in the test material barrel may erode the sample when the sample rotates, so that an erosion effect of real seawater on a ship plate steel can be simulated. However, in the actual situation, the erosion effect of water flow caused by only one stirring motor is still different from the erosion speed of real seawater. Therefore, the present disclosure further adds a counter-thrust propeller, thereby further increasing the erosion speed and the impact force of artificial seawater on the sample, and getting closer to the real situation.

### BRIEF DESCRIPTION OF THE DRAWINGS

In order to more clearly explain the technical solution in the embodiments of the present disclosure or the prior art, the drawings needed to be used in the embodiments will be briefly introduced hereinafter. Obviously, the drawings in the following description are only some embodiments of the present disclosure. For those skilled in the art, other drawings can be obtained according to these drawings without paying creative labor.

FIG. 1 is a schematic diagram of a structure of a test equipment for simulating erosion of a ship plate steel in polar broken ice waters in Embodiment 1;

FIG. 2 is a schematic diagram of an appearance of a test equipment for simulating erosion of a ship plate steel in polar broken ice waters in Embodiment 1;

FIG. 3 is a side view of a test equipment for simulating erosion of a ship plate steel in polar broken ice waters according to Embodiment 1;

FIG. 4 is a schematic diagram of a structure of a rotating sample clamp device in a test equipment for simulating erosion of a ship plate steel in polar broken ice waters in Embodiment 1;

FIG. 5 shows a rotating sample clamp device for simulating a bow of a ship of a test equipment for simulating erosion of a ship plate steel in polar broken ice waters in Embodiment 1;

FIG. 6 shows a rotating sample clamp device for simulating a middle of a ship of a test equipment for simulating erosion of a ship plate steel in polar broken ice waters in Embodiment 1;

FIG. 7 is a connection diagram of a circulating temperature control device in a test equipment for simulating erosion of a ship plate steel in polar broken ice waters in Embodiment 1; and

FIG. 8 is an internal schematic diagram of a test material barrel in a test equipment for simulating erosion of a ship plate steel in polar broken ice waters in Embodiment 1.

In the figures: 100—ice-water mixed wear test box; 110—reserved hole; 200—rotating sample clamp device; 210—stirring motor; 211—stirring support frame; 220-rotating sample clamp bracket; 221—sample fixing bolt; 222—clamp body; 230—test material barrel; 240—counter-thrust propeller; 250—flow meter; 300—circulating temperature control device; 310—constant temperature water bath box; 311—liquid inlet pipe; 312—liquid outlet pipe; 320—circulating temperature control outer barrel; 330—temperature sensor.

### DETAILED DESCRIPTION OF THE EMBODIMENTS

The technical solution in the embodiment of the present disclosure will be clearly and completely described with reference to the drawings in the embodiment of the present disclosure hereinafter. Obviously, the described embodiments are only some of the embodiments of the present disclosure, rather than all of the embodiments. Based on the embodiments in the present disclosure, all other embodiments obtained by those skilled in the art without paying creative labor belong to the scope of protection of the present disclosure.

An objective of the present disclosure is to provide a test equipment and a test method for simulating erosion of a ship plate steel in polar broken ice waters, thereby solving the above problems existing in the prior art, and accurately controlling the erosion speed and the impact force on the sample.

To make the above objective, features and advantages of the present disclosure more obvious and understandable, the present disclosure will be further described in detail with reference to the drawings and the specific embodiments.

### Embodiment 1

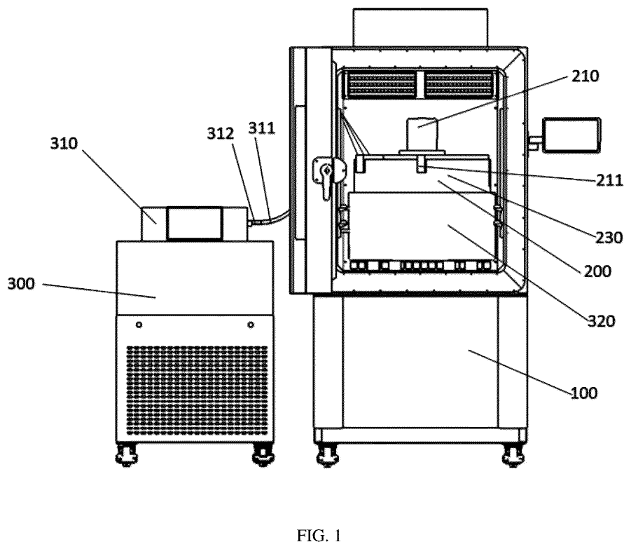

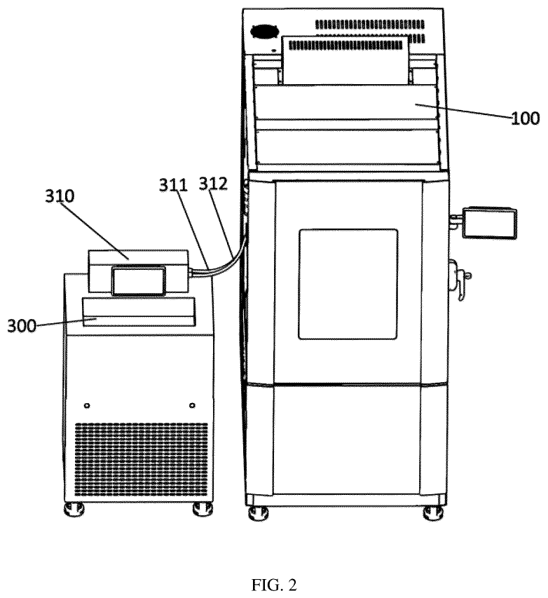

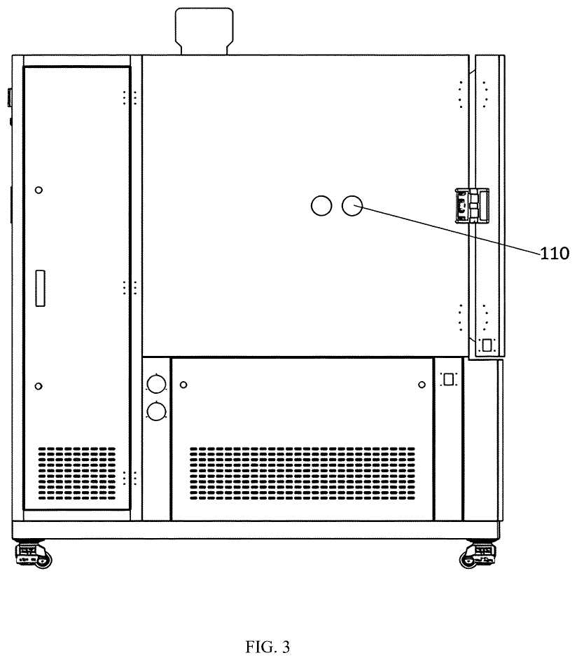

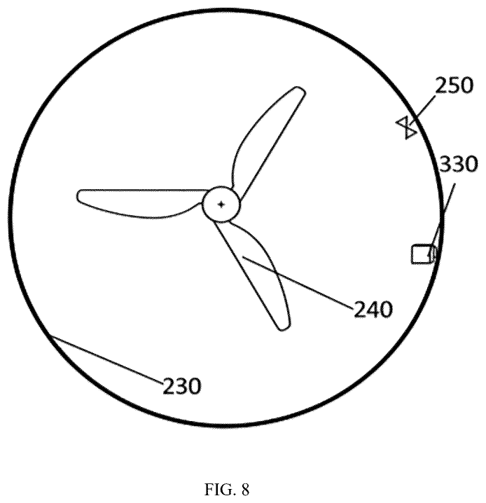

As shown in FIG. 1 to FIG. 8, this embodiment provides a test equipment for simulating erosion of a ship plate steel in polar broken ice waters, including an ice-water mixed wear test box 100, a rotating sample clamp device 200, and a circulating temperature control device 300.

The rotating sample clamp device 200 is installed inside the ice-water mixed wear test box 100. The rotating sample clamp device 200 includes a stirring motor 210. The stirring motor 210 is installed on a stirring support frame 211 by a screw. The stirring support frame 211 is installable on a test material barrel 230. An output shaft of the stirring motor 210 is connected with a rotating sample clamp bracket 220, and the output shaft of the stirring motor 210 is located at a center of the rotating sample clamp bracket 220. A plurality of clamp bodies 222 are connected to a periphery of the rotating sample clamp bracket 220. The clamp bodies 222 are configured to fix samples. A propeller-driven motor is installed on a bottom surface of an outer layer of the test material barrel 230. In order to prevent the propeller-driven motor from being in contact with the circulating solution, a protective cover may be arranged outside the propeller-driven motor to isolate the propeller-driven motor. An output shaft of the propeller-driven motor passes through a bottom of the test material barrel 230 and is connected with a counter-thrust propeller 240. The counter-thrust propeller 240 is located below the inside of the test material barrel 230.

The circulating temperature control device 300 includes a constant temperature water bath box 310 and a circulating temperature control outer barrel 320. The constant temperature water bath box 310 is located outside the ice-water mixed wear test box 100. The circulating temperature control outer barrel 320 is located inside the ice-water mixed wear test box 100, and the test material barrel 230 is placed inside the circulating temperature control outer barrel 320. A liquid inlet pipe 311 and a liquid outlet pipe 312 are connected between the constant temperature water bath box 310 and the circulating temperature control outer barrel 320. The constant temperature water bath box 310 is the prior art, so its structure will not be described in detail. Its general working principle is that the constant temperature water bath box 310 can heat or cool the circulating solution, and then the heated or cooled circulating solution in the constant temperature water bath box 310 may be transported to an annular space between the circulating temperature control outer barrel 320 and the test material barrel 230 through the liquid inlet pipe 311, thereby performing heat exchange on the artificial seawater in the test material barrel 230. In this way, the artificial seawater is kept in a constant temperature state. The circulating solution after heat exchange may flow out of the liquid outlet pipe 312 and flow into the constant temperature water bath box 310 again to decrease or increase the temperature (depending on the test requirements), thereby completing a circulating process. The circulating temperature control device 300 is turned on to simulate a polar environment below or above the freezing point of seawater. At the same time, special requirements are provided for test variables such as an ice-water ratio and an ice shape. The circulating solution is selected in the constant temperature water bath box 310 according to the simulated environmental temperature. A low-temperature environmental test is carried out, and the freezing temperature of the selected circulating solution should be lower than the test temperature to avoid freezing. A high-temperature environment test is carried out, and the vaporization temperature of the selected circulating solution should be higher than the test temperature to avoid volatilization. Generally, alcohol is used as the circulating solution.

In order to meet requirements of some special test conditions, for example, when the simulated polar atmospheric temperature is below −1.8° C. to 0° C., a solution system cannot control special test variables such as the ice-water ratio and the ice shape. In essence, because the ice-forming temperature of the solution system needs to be as low as −1.8° C. (that is, the freezing point of seawater is about −1.8° C.). Seawater freezes. With the increase of the ice age, the salt gradually precipitates. Millennial ice in the polar environment is defaulted to pure water ice, whose melting point is 0° C. In order to ensure that ice cubes do not melt and seawater does not freeze, the technical solution proposed by the present disclosure is as follows.

The temperature of the solution system is kept at the freezing point of a sea ice-seawater mixed solution system by adding the circulating temperature control device 300 to the test material barrel 230. For special test requirements, a large number of test results show that the atmospheric temperature only controls a contact interface between the sea ice-seawater mixed solution system and air. Because the density of ice is less than that of seawater, ice may float on a surface of the artificial seawater. The low-temperature atmosphere does not affect test variables such as the ice shape and the ice-water ratio. At the same time, the water flow in the real environment keeps a deep-water area in a non-freezing state. That is, the temperature in the deep-water area is higher than the surface temperature of the solution and greater than or equal to the freezing point temperature. Therefore, the temperature in the deep-water area should be controlled near the freezing point to ensure that seawater may not freeze and affect the ice-water ratio of the surface. The water temperature in the deep-water area is controlled at about −1.8° C. to 0° C. (set according to the specific requirements of the test), and the water surface temperature (that is, the temperature of ice floating on the surface) is the atmospheric temperature, which can be adjusted according to the actual situation of the real environment.

In actual use, the artificial seawater is first added to the test material barrel 230, and the constant temperature water bath box 310 is turned on to deliver the circulating solution to the circulating temperature control outer barrel 320. At the same time, the samples are installed on the clamp bodies 222 and extend into the test material barrel. The stirring motor 210 is turned on, and the stirring motor 210 drives the samples to rotate in the artificial seawater to simulate navigation of the ship. The artificial seawater may have an erosion effect on the samples. However, only depending on the stirring motor 210, there is still a specific gap between the erosion effect of the artificial seawater on the samples and the real situation. At this time, the propeller-driven motor can be turned on to drive the counter-thrust propeller 240 to rotate, and the counter-thrust propeller 240 rotates in a direction opposite to that of the stirring motor 210 (or the clamp body 222) at the same rotating speed, so that the erosion speed and the erosion intensity of the artificial seawater on the samples can be further improved, thereby being more suitable for the real situation.

In this embodiment, as shown in FIG. 4, the stirring support frame 211 is of an I-shaped structure as a whole. Specifically, the stirring support frame 211 includes a support main body and four telescopic clamping plates. The four telescopic clamping plates are installed at four corners of the support main body, respectively. The support main body is a rectangular plate in the middle and configured to fix the stirring motor 210. Each of the four corners of the support main body is provided with a first positioning hole. Each of the four telescopic clamping plates is provided with a plurality of second positioning holes at intervals. The first positioning hole is connected with one of the second positioning holes through a positioning bolt. That is, the positioning bolt passes through the first positioning hole and the second positioning hole in sequence and then is in threaded connection with a corresponding nut to fix the support main body and the telescopic clamping plate. Moreover, when the first positioning hole correspond to a different second positioning hole, the telescopic clamping plates extend to different lengths to clamp the test material barrels 230 with different sizes. Moreover, in order to facilitate the four telescopic clamping plates to better clamp the test material barrel 230, the telescopic clamping plate is arranged in an L-shaped structure, a horizontal surface of the telescopic clamping plate is provided with a second positioning hole and connected with the support main body, and a vertical surface of the telescopic clamping plate is configured to clamp an outer wall of the test material barrel 230.

In this embodiment, the rotating sample clamp bracket 220 is a cross-shaped member. Four clamp bodies 222 are arranged. Each of four ends of the rotating sample clamp bracket 220 is connected with one of the clamp bodies 222. The clamp body 222 is provided with a plurality of sample empty grooves distributed vertically. Specifically, three sample empty grooves are arranged, all of which are rectangular empty grooves with the same size. Here, it should be noted that the plurality of sample empty grooves are arranged to provide installation positions with different heights for samples, thereby simulating an ice-water erosion process at different depths of the ship hull.

Two sides of each sample empty groove are in threaded connection with two sample fixing bolt 221, respectively, and the sample is clamped between the two sample fixing bolts 221. The sample is of a steel plate structure for a ship plate. The steel plate is fixed by the sample fixing bolt 221 because a gap between the two sample fixing bolts 221 may be adjusted by loosening or tightening the sample fixing bolt 221, thereby clamping samples with different sizes.

The circulating temperature control outer barrel 320 is sleeved outside the test material barrel 230. Because a barrel wall of the test material barrel 230 is preferentially heated, a diameter of the rotating sample clamp bracket 220 should be as the same as that of the test material barrel 230 as possible (or the clamp body 222 should be as close as possible to an inner wall of the test material barrel 230), thereby ensuring that the solution system is fully stirred and heat is distributed uniformly.

In this embodiment, the ice-water mixed wear test box 100 is a common high-low temperature test box in the laboratory, which can control the internal temperature (this is the prior art) to simulate the extreme ambient atmospheric temperature.

In this embodiment, a side wall of the ice-water mixed wear test box 100 is provided with a plurality of reserved holes 110. Each of the reserved holes 110 is configured for passage of the liquid inlet pipe 311, the liquid outlet pipe 312, and an electric wire. Moreover, in order to further improve sealing performance of the reserved hole 110, after the liquid inlet pipe 311 and the liquid outlet pipe 312 pass through the reserved hole 110, a sealing ring can be installed to seal a gap between each pipe and the reserved hole 110, thereby slowing down heat exchange efficiency between the inside and the outside of the ice-water mixed wear test box 100.

In this embodiment, an inner wall of the ice-water mixed wear test box 100 and an inner wall of the test material barrel 230 are both coated with nonmetallic coatings. The nonmetallic coatings may be an existing epoxy zinc-rich primer. On the one hand, due to liquid splashing, the epoxy zinc-rich primer is applied to prolong a service life of the ice-water mixed wear test box 100. On the other hand, galvanic corrosion of the ice-water mixed wear test box 100 and the test material barrel 230 in the humid environment is avoided, and test accuracy is ensured.

In this embodiment, a flow meter 250 is installed inside the test material barrel 230 to monitor a flow rate of the artificial seawater.

In this embodiment, a temperature sensor 330 is installed inside the test material barrel 230 to monitor the temperature of the artificial seawater. Here, it should be noted that the device such as the ice-water mixed wear test box 100, the constant temperature water bath box 310, the stirring motor 210, and the propeller-driven motor are all electrically connected with a control device, and operation of each device is controlled by the control device. Moreover, the flow meter 250 and the temperature sensor 330 are also electrically connected with the control device. The flow meter 250 and the temperature sensor 330 may transmit a flow rate signal and a temperature signal to the control device in real time. Then, the control device sends a corresponding control signal to the corresponding device (such as the stirring motor 210, the propeller-driven motor, and the constant temperature water bath box 310) according to the relevant data to control the operation. For the control device, an existing industrial personal computer or background host can be used.

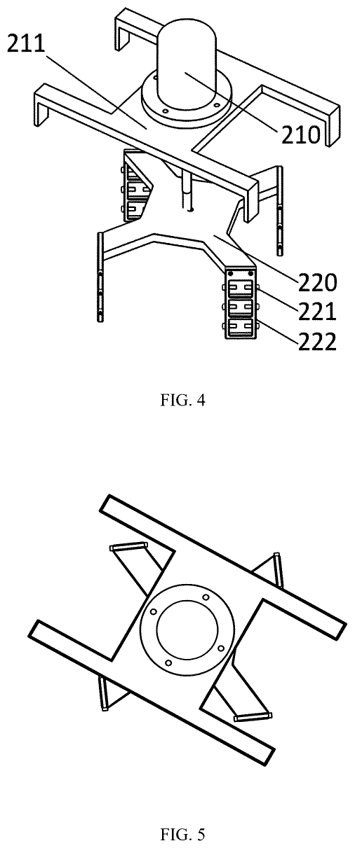

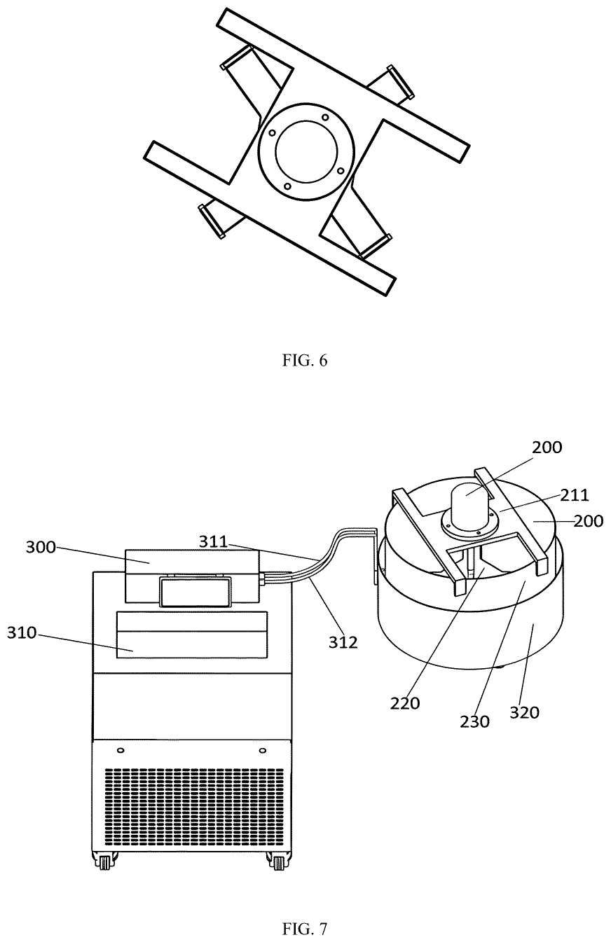

In this embodiment, an erosion angle is formed between the clamp bodies 222 and a tangential direction of the clamp bodies 222 when the clamp bodies 222 rotate, and the erosion angle ranges from 0° to 90°, which is specifically shown in FIG. 4 to FIG. 6. FIG. 4 and FIG. 5 illustrate an embodiment, and FIG. 6 illustrates an other embodiment. As can be seen from FIG. 5 and FIG. 6, ends of the rotating sample clamp bracket 220 are not the same, and an inclination angle is an angle of a plane where the clamp body 222 is located. The inclination angle may be customized according to the actual requirements, and the goal is to simulate an ice-water erosion process from the bow of a ship to the stern of a ship in broken ice waters.

### Embodiment 2

This embodiment provides a test method carried out by a test equipment for simulating erosion of a ship plate steel in polar broken ice waters. Based on the test equipment for simulating erosion of the ship plate steel in polar broken ice waters disclosed in Embodiment 1, the test method includes the following steps:
S1, tightness of the equipment (such as the ice-water mixed wear test box 100 and the constant temperature water bath box 310) tightness and safety of circuit configuration are checked;
S2, temperature and humidity of an ice-water mixed wear test box 100 are set, artificial seawater is added into a test material barrel 230, heat of the artificial seawater is uniformly distributed through rotation of a counter-thrust propeller 240, and the temperature of the artificial seawater is detected through a temperature sensor 330;
S3, after the temperature of the artificial seawater in the test material barrel 230 is stabilized, a circulating temperature control device 300 is activated, and the temperature of the artificial seawater is adjusted to be within a range of −1.8° C. and 0° C. ;
S4, prepared ice cubes is added into the test material barrel 230 when the temperature of the artificial seawater is stabilized between −1.8° C. and 0° C., in which variables such as an ice-water ratio (an ice amount), an ice shape, an ice particle size, and the like need to be taken into account for the added ice cubes;
S5, rotating sample clamp brackets 220 with different erosion angles are selected according to a specific research position of a ship hull, samples are installed on clamp bodies 222, a navigation distance is calculated according to a radius, a rotation speed, and rotation time of the rotating sample clamp bracket 220, a stirring motor 210 is activated, a rotation speed of the stirring motor 210 is set, and starting timing; and
S6, after the test is finished, the sample is dried and sealed or dried for characterization, in which specifically, the erosion morphology and the rust layer composition of the sample surface can be characterized by the detection means such as Confocal Laser Scanning Microscopy (CLSM), Scanning Electron Microscopy (SEM), and Energy Dispersive Spectroscopy (EDS).

When the simulated polar atmospheric temperature is lower or higher than −1.8° C. to 0° C., there are five points to explain whether to turn on the circulating temperature control device 300.
1. When the simulated polar atmospheric temperature is about −1.8° C. to 0° C., variables such as the ice-water ratio and the ice shape of the sea ice-seawater mixed solution remain unchanged. That is, it is unnecessary to turn on the circulating temperature control device 300.
2. When the simulated temperature is lower than the polar atmospheric temperature of −1.8° C. to 0° C., and there is no special test requirement for the sea ice-seawater mixed solution system, it is unnecessary to turn on the circulating temperature control device 300.
3. When the simulated temperature is higher than the polar atmospheric temperature of 0° C., the seawater is in a non-freezing state, and it is unnecessary to turn on the circulating temperature control device 300.
4. When the simulated temperature is lower than the polar atmospheric temperature of −1.8° C. to 0° C., and there are special test requirements for the sea ice-seawater mixed solution system, it is necessary to turn on the circulating temperature control device 300 to ensure that the temperature in the deep-water area of the sea ice-seawater mixed solution system is kept at −1.8° C. to 0° C.
5.When the simulated temperature is higher than the polar atmospheric temperature of 0° C., and there is a simulation test of broken ice on the water surface, it is necessary to turn on the circulating temperature control device 300 to ensure the temperature in the deep-water area of the sea ice-seawater mixed solution system is kept at −1.8° C. to 0° C.

In the present disclosure, specific examples are used to explain the principle and implementation of the present disclosure. The description of the above embodiments is only used to help understand the method and the core idea of the present disclosure. At the same time, for those skilled in the art, according to the idea of the present disclosure, there will be changes in the specific implementation and the application scope. To sum up, the contents of this specification should not be construed as limiting the present disclosure.

What is claimed is:

1. A test equipment for simulating erosion of a ship plate steel in polar broken ice waters, comprising an ice-water mixed wear test box (100), a rotating sample clamp device (200), and a circulating temperature control device (300);
the rotating sample clamp device (200) is installed inside the ice-water mixed wear test box (100), the rotating sample clamp device (200) comprises a stirring motor (210) installed on a stirring support frame (211), the stirring support frame (211) is installable on a test material barrel (230), an output shaft of the stirring motor (210) is connected with a rotating sample clamp bracket (220), the rotating sample clamp bracket (220) is connected with a plurality of clamp bodies (222), the clamp bodies (222) are configured to fix samples, a propeller-driven motor is installed on a bottom surface of the test material barrel (230), an output shaft of the propeller-driven motor is connected with a counter-thrust propeller (240), and the counter-thrust propeller (240) is located inside the test material barrel (230); and
the circulating temperature control device (300) comprises a constant temperature water bath box (310) and a circulating temperature control outer barrel (320), the test material barrel (230) is placed inside the circulating temperature control outer barrel (320), and a liquid inlet pipe (311) and a liquid outlet pipe (312) are connected between the constant temperature water bath box (310) and the circulating temperature control outer barrel (320).

2. The test equipment for simulating erosion of the ship plate steel in polar broken ice waters according to claim 1, wherein the stirring support frame (211) comprises a support main body and four telescopic clamping plates, each of four corners of the support main body is provided with a first positioning hole, each of the four telescopic clamping plates is provided with a plurality of second positioning holes at intervals, the first positioning hole is connected with one of the second positioning holes through a positioning bolt, and the four telescopic clamping plates are configured to clamp the test material barrel (230).

3. The test equipment for simulating erosion of the ship plate steel in polar broken ice waters according to claim 1, wherein the rotating sample clamp bracket (220) is a cross-shaped member, each of four ends of the rotating sample clamp bracket (220) is connected with one of the clamp bodies (222), each clamp body (222) is provided with a plurality of sample empty grooves distributed vertically, two sides of each sample empty groove are in threaded connection with two sample fixing bolts (221), respectively, and a sample is clamped between the two sample fixing bolts (221).

4. The test equipment for simulating erosion of the ship plate steel in polar broken ice waters according to claim 1, wherein the ice-water mixed wear test box (100) is a high-low temperature test box.

5. The test equipment for simulating erosion of the ship plate steel in polar broken ice waters according to claim 1, wherein a side wall of the ice-water mixed wear test box (100) is provided with a plurality of reserved holes (110).

6. The test equipment for simulating erosion of the ship plate steel in polar broken ice waters according to claim 1, wherein an inner wall of the ice-water mixed wear test box (100) and an inner wall of the test material barrel (230) are both coated with nonmetallic coatings.

7. The test equipment for simulating erosion of the ship plate steel in polar broken ice waters according to claim 1, wherein a flow meter (250) is installed inside the test material barrel (230).

8. The test equipment for simulating erosion of the ship plate steel in polar broken ice waters according to claim 1, wherein a temperature sensor (330) is installed inside the test material barrel (230).

9. The test equipment for simulating erosion of the ship plate steel in polar broken ice waters according to claim 1, wherein an erosion angle is formed between the clamp bodies (222) and a tangential direction of the clamp bodies when the clamp bodies (222) rotate, and the erosion angle ranges from 0° to 90°.

10. A test method carried out by a test equipment for simulating erosion of a ship plate steel in polar broken ice waters, wherein based on the test equipment for simulating erosion of the ship plate steel in polar broken ice waters according to claim 1, the method comprises the following steps:
S1, checking tightness of the equipment and safety of circuit configuration;
S2, setting temperature and humidity of an ice-water mixed wear test box (100), adding artificial seawater into a test material barrel (230), uniformly distributing heat of the artificial seawater through rotation of a counter-thrust propeller (240), and detecting the temperature of the artificial seawater through a temperature sensor (330);
S3, after the temperature of the artificial seawater in the test material barrel (230) is stabilized, turning on a circulating temperature control device (300), and adjusting the temperature of the artificial seawater between −1.8° C. and 0° C.;
S4, adding prepared ice cubes into the test material barrel (230) when the temperature of the artificial seawater is stabilized between −1.8° C. and 0° C.;
S5, selecting rotating sample clamp brackets (220) with different erosion angles according to a specific research position of a ship hull, installing samples on clamp bodies (222), calculating a navigation distance according to a radius, a rotation speed, and rotation time of the rotating sample clamp bracket (220), turning on a stirring motor (210), setting a rotation speed of the stirring motor (210), and starting timing; and
S6, after the test is finished, drying the samples for sealing or drying the samples for characterization.

11. A test method carried out by a test equipment for simulating erosion of a ship plate steel in polar broken ice waters, wherein based on the test equipment for simulating erosion of the ship plate steel in polar broken ice waters according to claim 2, the method comprises the following steps:
S1, checking tightness of the equipment and safety of circuit configuration;
S2, setting temperature and humidity of an ice-water mixed wear test box (100), adding artificial seawater into a test material barrel (230), uniformly distributing heat of the artificial seawater through rotation of a counter-thrust propeller (240), and detecting the temperature of the artificial seawater through a temperature sensor (330);
S3, after the temperature of the artificial seawater in the test material barrel (230) is stabilized, turning on a circulating temperature control device (300), and adjusting the temperature of the artificial seawater between −1.8° C. and 0° C.;
S4, adding prepared ice cubes into the test material barrel (230) when the temperature of the artificial seawater is stabilized between −1.8° C. and 0° C.;
S5, selecting rotating sample clamp brackets (220) with different erosion angles according to a specific research position of a ship hull, installing samples on clamp bodies (222), calculating a navigation distance according to a radius, a rotation speed, and rotation time of the rotating sample clamp bracket (220), turning on a stirring motor (210), setting a rotation speed of the stirring motor (210), and starting timing; and
S6, after the test is finished, drying the samples for sealing or drying the samples for characterization.

12. A test method carried out by a test equipment for simulating erosion of a ship plate steel in polar broken ice waters, wherein based on the test equipment for simulating erosion of the ship plate steel in polar broken ice waters according to claim 3, the method comprises the following steps:
S1, checking tightness of the equipment and safety of circuit configuration;
S2, setting temperature and humidity of an ice-water mixed wear test box (100), adding artificial seawater into a test material barrel (230), uniformly distributing heat of the artificial seawater through rotation of a counter-thrust propeller (240), and detecting the temperature of the artificial seawater through a temperature sensor (330);
S3, after the temperature of the artificial seawater in the test material barrel (230) is stabilized, turning on a circulating temperature control device (300), and adjusting the temperature of the artificial seawater between −1.8° C. and 0° C.;
S4, adding prepared ice cubes into the test material barrel (230) when the temperature of the artificial seawater is stabilized between −1.8° C. and 0° C.;
S5, selecting rotating sample clamp brackets (220) with different erosion angles according to a specific research position of a ship hull, installing samples on clamp bodies (222), calculating a navigation distance according to a radius, a rotation speed, and rotation time of the rotating sample clamp bracket (220), turning on a stirring motor (210), setting a rotation speed of the stirring motor (210), and starting timing; and
S6, after the test is finished, drying the samples for sealing or drying the samples for characterization.

13. A test method carried out by a test equipment for simulating erosion of a ship plate steel in polar broken ice waters, wherein based on the test equipment for simulating erosion of the ship plate steel in polar broken ice waters according to claim 4, the method comprises the following steps:
S1, checking tightness of the equipment and safety of circuit configuration;
S2, setting temperature and humidity of an ice-water mixed wear test box (100), adding artificial seawater into a test material barrel (230), uniformly distributing heat of the artificial seawater through rotation of a counter-thrust propeller (240), and detecting the temperature of the artificial seawater through a temperature sensor (330);
S3, after the temperature of the artificial seawater in the test material barrel (230) is stabilized, turning on a circulating temperature control device (300), and adjusting the temperature of the artificial seawater between −1.8° C. and 0° C.;
S4, adding prepared ice cubes into the test material barrel (230) when the temperature of the artificial seawater is stabilized between −1.8° C. and 0° C.;
S5, selecting rotating sample clamp brackets (220) with different erosion angles according to a specific research position of a ship hull, installing samples on clamp bodies (222), calculating a navigation distance according to a radius, a rotation speed, and rotation time of the rotating sample clamp bracket (220), turning on a stirring motor (210), setting a rotation speed of the stirring motor (210), and starting timing; and
S6, after the test is finished, drying the samples for sealing or drying the samples for characterization.

14. A test method carried out by a test equipment for simulating erosion of a ship plate steel in polar broken ice waters, wherein based on the test equipment for simulating erosion of the ship plate steel in polar broken ice waters according to claim 5, the method comprises the following steps:
S1, checking tightness of the equipment and safety of circuit configuration;
S2, setting temperature and humidity of an ice-water mixed wear test box (100), adding artificial seawater into a test material barrel (230), uniformly distributing heat of the artificial seawater through rotation of a counter-thrust propeller (240), and detecting the temperature of the artificial seawater through a temperature sensor (330);
S3, after the temperature of the artificial seawater in the test material barrel (230) is stabilized, turning on a circulating temperature control device (300), and adjusting the temperature of the artificial seawater between −1.8° C. and 0° C.;
S4, adding prepared ice cubes into the test material barrel (230) when the temperature of the artificial seawater is stabilized between −1.8° C. and 0° C.;
S5, selecting rotating sample clamp brackets (220) with different erosion angles according to a specific research position of a ship hull, installing samples on clamp bodies (222), calculating a navigation distance according to a radius, a rotation speed, and rotation time of the rotating sample clamp bracket (220), turning on a stirring motor (210), setting a rotation speed of the stirring motor (210), and starting timing; and
S6, after the test is finished, drying the samples for sealing or drying the samples for characterization.

15. A test method carried out by a test equipment for simulating erosion of a ship plate steel in polar broken ice waters, wherein based on the test equipment for simulating erosion of the ship plate steel in polar broken ice waters according to claim 6, the method comprises the following steps:
S1, checking tightness of the equipment and safety of circuit configuration;
S2, setting temperature and humidity of an ice-water mixed wear test box (100), adding artificial seawater into a test material barrel (230), uniformly distributing heat of the artificial seawater through rotation of a counter-thrust propeller (240), and detecting the temperature of the artificial seawater through a temperature sensor (330);
S3, after the temperature of the artificial seawater in the test material barrel (230) is stabilized, turning on a circulating temperature control device (300), and adjusting the temperature of the artificial seawater between −1.8° C. and 0° C.;
S4, adding prepared ice cubes into the test material barrel (230) when the temperature of the artificial seawater is stabilized between −1.8° C. and 0° C.;
S5, selecting rotating sample clamp brackets (220) with different erosion angles according to a specific research position of a ship hull, installing samples on clamp bodies (222), calculating a navigation distance according to a radius, a rotation speed, and rotation time of the rotating sample clamp bracket (220), turning on a stirring motor (210), setting a rotation speed of the stirring motor (210), and starting timing; and
S6, after the test is finished, drying the samples for sealing or drying the samples for characterization.

16. A test method carried out by a test equipment for simulating erosion of a ship plate steel in polar broken ice waters, wherein based on the test equipment for simulating erosion of the ship plate steel in polar broken ice waters according to claim 7, the method comprises the following steps:
S1, checking tightness of the equipment and safety of circuit configuration;
S2, setting temperature and humidity of an ice-water mixed wear test box (100), adding artificial seawater into a test material barrel (230), uniformly distributing heat of the artificial seawater through rotation of a counter-thrust propeller (240), and detecting the temperature of the artificial seawater through a temperature sensor (330);
S3, after the temperature of the artificial seawater in the test material barrel (230) is stabilized, turning on a circulating temperature control device (300), and adjusting the temperature of the artificial seawater between −1.8° C. and 0° C.;
S4, adding prepared ice cubes into the test material barrel (230) when the temperature of the artificial seawater is stabilized between −1.8° C. and 0° C.;
S5, selecting rotating sample clamp brackets (220) with different erosion angles according to a specific research position of a ship hull, installing samples on clamp bodies (222), calculating a navigation distance according to a radius, a rotation speed, and rotation time of the rotating sample clamp bracket (220), turning on a stirring motor (210), setting a rotation speed of the stirring motor (210), and starting timing; and
S6, after the test is finished, drying the samples for sealing or drying the samples for characterization.

17. A test method carried out by a test equipment for simulating erosion of a ship plate steel in polar broken ice waters, wherein based on the test equipment for simulating erosion of the ship plate steel in polar broken ice waters according to claim 8, the method comprises the following steps:
S1, checking tightness of the equipment and safety of circuit configuration;
S2, setting temperature and humidity of an ice-water mixed wear test box (100), adding artificial seawater into a test material barrel (230), uniformly distributing heat of the artificial seawater through rotation of a counter-thrust propeller (240), and detecting the temperature of the artificial seawater through a temperature sensor (330);
S3, after the temperature of the artificial seawater in the test material barrel (230) is stabilized, turning on a circulating temperature control device (300), and adjusting the temperature of the artificial seawater between −1.8° C. and 0° C.;
S4, adding prepared ice cubes into the test material barrel (230) when the temperature of the artificial seawater is stabilized between −1.8° C. and 0° C.;
S5, selecting rotating sample clamp brackets (220) with different erosion angles according to a specific research position of a ship hull, installing samples on clamp bodies (222), calculating a navigation distance according to a radius, a rotation speed, and rotation time of the rotating sample clamp bracket (220), turning on a stirring motor (210), setting a rotation speed of the stirring motor (210), and starting timing; and
S6, after the test is finished, drying the samples for sealing or drying the samples for characterization.

18. A test method carried out by a test equipment for simulating erosion of a ship plate steel in polar broken ice waters, wherein based on the test equipment for simulating erosion of the ship plate steel in polar broken ice waters according to claim 9, the method comprises the following steps:
S1, checking tightness of the equipment and safety of circuit configuration;
S2, setting temperature and humidity of an ice-water mixed wear test box (100), adding artificial seawater into a test material barrel (230), uniformly distributing heat of the artificial seawater through rotation of a counter-thrust propeller (240), and detecting the temperature of the artificial seawater through a temperature sensor (330);
S3, after the temperature of the artificial seawater in the test material barrel (230) is stabilized, turning on a circulating temperature control device (300), and adjusting the temperature of the artificial seawater between −1.8° C. and 0° C.;
S4, adding prepared ice cubes into the test material barrel (230) when the temperature of the artificial seawater is stabilized between −1.8° C. and 0° C.;
S5, selecting rotating sample clamp brackets (220) with different erosion angles according to a specific research position of a ship hull, installing samples on clamp bodies (222), calculating a navigation distance according to a radius, a rotation speed, and rotation time of the rotating sample clamp bracket (220), turning on a stirring motor (210), setting a rotation speed of the stirring motor (210), and starting timing; and
S6, after the test is finished, drying the samples for sealing or drying the samples for characterization.
